(19) United States
(12) Patent Application Publication
(10) Pub. No.: US 2007/0000322 A1
(43) Pub. Date: Jan. 4, 2007

(54) Tire balancing devices and methods

(76) Inventor: Richard J. Gessler JR., Stillwater, MN (US)

Correspondence Address: Mr. Richard J. Gessler Jr., 1312 Macey Court, Stilwater, MN, 55082, US

(21) Appl. No.: 11/405,201

(22) Filed: Apr. 17, 2006

Related U.S. Application Data
(60) Provisional application No. 60/672,820, filed on Apr. 19, 2005.

(51) Int. Cl. G01M 1/16

(52) U.S. Cl. 73/460

(57) ABSTRACT

Apparatus for performing static balancing or axial or radial run-out inspection on an axially symmetrical disc or wheel assembly. The apparatus consists of a contemplated design of a rigid frame portion with features for easy transport, wheel run-out inspection attachments with high-resolution adjustment, anti-vibration and anti-marring non-skid isomeric feet, integrated frame hand-holds, integrated arbor storage that utilizes the primary locking function of the tool-less arbor tooling itself as a means to engage the arbor shaft into the frame, tool-less quick-changeover arbors of a locking ball and ramp design, arbors that act as a means of a hand-hold for transport, and arbors for non-traditional rotating member mounting to address the issue of thin cross-sectional wheel assemblies.

### FIELD OF THE INVENTION

The invention relates to the field of shop accessories, and more particularly to devices and methods for balancing wheel/tire assemblies.

### BACKGROUND OF THE INVENTION

Many vehicles can benefit from having properly balanced tires, for a variety of reasons. These reasons may include comfort, reduced stress on structural components of the vehicle, safety, stability, and handling. A wheel is defined as being properly balanced when the mass of the rotating body is evenly distributed about the axle.

Two methods exist as a means to balance tires. Dynamic and static balancing. This invention includes elements that may be used in both types of balancing methods, though the construction of the example used here is of a static method.

Regarding the static balancers currently on the market and in this invention, two main components make up the device, a frame and an arbor. The frame supports a friction reducing mechanism, typically low-drag ball bearings, or air-bearings, which in turn support the arbor. The arbor is a device that holds the rotating assembly concentric to the shaft, which is supported by the above-mentioned frame.

To provide a means of mounting a wide variety of rotating assemblies to the arbor, a locking device is employed. This device can be locked firmly to the rotating assembly by means of a threaded shaft or set screws. Many of these locking devices require the use of tools, and over time they may create a high degree of wear on their corresponding components, thereby increasing the cost of performing the tire balancing. In addition, the current offering of static balancing systems do not offer an integrated protective storage area for their arbors (when not in use), or a convenient method of transporting the equipment.

It is the goal of the invention concerned in this document to reduce the time required to perform the tire balancing while concurrently reducing the continued operating costs of said equipment, including features that reduce the likelihood of increased costs due to component damage.

### SUMMARY OF THE INVENTION

The tire balancing device herein consists of a frame and an arbor to facilitate concentric engagement of the wheel through the means of at least one locking mechanism. The frame will support the arbor on a friction reducing medium, ball bearings in this context, while the arbor supports the wheel/tire assembly. The locking mechanism on the arbor may consist of an engaging member along with a self-locking member that is activated without the use of set screws or fasteners that require additional tools. Due to this provision, the invention disclosed herein is easier to use, faster, and has a lower overall operating cost than devices using other methods. Additionally, said invention has provisions integrated into the frame for arbor storage and handles for simple transportation. Notably, the arbor storage function operates by using the primary engagement methods of said arbor to further simplify operation. This storage serves two purposes, the first of which is to reduce the likelihood of damage to the arbor by providing secure placement, and the seconds is to provide additional means of carrying the invention, as the arbor shaft will act as a carrying handle. In some embodiments, the locking mechanism can include a cone shaped fixture and a quick release locking device such as a Grip Fast™ locking collar. In some embodiments, the device can include a first and second locking mechanism, while in others it can consist of a cup member and a locking mechanism.

In addition to the features described above that reduce the time required for operating, other features can be considered to be of benefit such as the increased durability of the balancing stand and arbor through the use of quality materials such as stainless steel, nylatron, or other high-performing materials. Of benefit to the work surfaces that the device is operated on, the base of the invention can be provided with polymeric feet and/or a polymeric coating to reduce wear, scratching, or sliding of the balancer while in operation. For inspection or construction of wheels, an axial runout visual indicator can be included. This indicator can include a polymeric coating to prevent damage to wheels that come in contact with the indicator during use.

In one aspect, the invention pertains to the locking mechanism including the cone shaped member and a tool-less locking member, wherein the cone shaped engagement member and the self-locking member have a bore adapted to receive an arbor, and wherein the self-locking mechanism is a locking collar. In this embodiment, the locking collar can be a Grip Fast™ locking collar.

In a second aspect, the invention pertains to a device for balancing a tire including an arbor, a frame to hold and position the arbor and at least one locking mechanism adapted to fit on to the arbor, the locking mechanism includes an engagement member and a locking collar. In these embodiments, the locking collar can secure a wheel assembly to the arbor without the use of set screws or additional tools.

In a third aspect, the invention pertains to a method of balancing a tire mounted to a rim to form a wheel assembly, wherein the wheel assembly is secured to the arbor by a locking mechanism comprising an engagement member and a locking collar having a flange portion, the method including the step of actuating the flange portion to unlock the locking mechanism. In these embodiments, the method can further include the step of sliding the engagement member away from the wheel assembly.

### BRIEF DESCRIPTION OF THE FIGURES

FIG. 1 is a perspective view of a tire balancing device, with the arbor depicted in a stored position.

FIG. 2 is a perspective view of the tire balancing device of FIG. 1, with the arbor depicted in a use position.

FIG. 3 is a side view of a locking mechanism engaged with an arbor, the locking mechanism including a cone shaped engagement portion and a self locking member having a flange portion.

FIG. 4 is a side view of the locking mechanism of FIG. 3, wherein the flange portion of the locking mechanism being actuated to release the locking mechanism.

FIG. 4A is a perspective view of an arbor and two cone-shaped engagement member with step-like notches.

FIG. 4B is a perspective view of an arbor and two cross-shaped engagement portions each having two plates that intersect at about a 90 degree angle.

FIG. 5 is a perspective view of a wheel assembly secured to tire balancing device of FIG. 1.

FIG. 6 is a perspective view of a cup member connected to an arbor, wherein the cup member is contacting a wheel rim.

FIG. 7 is a perspective view of the embodiment of FIG. 6 depicting the opposite side of the wheel rim, wherein a locking mechanism is depicted in contact with the wheel rim.

### DETAILED DESCRIPTION OF THE INVENTION

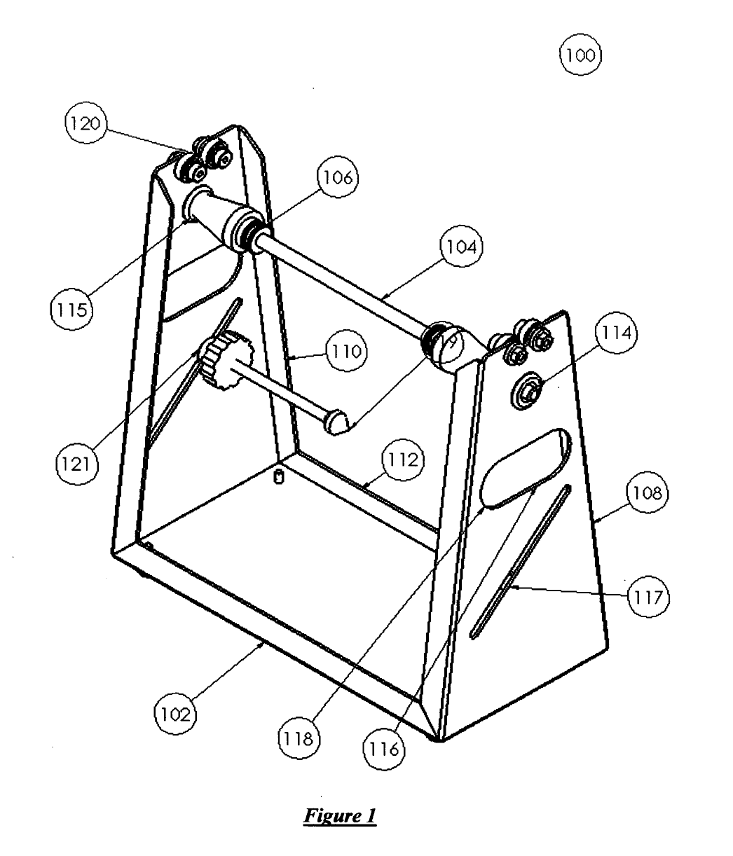

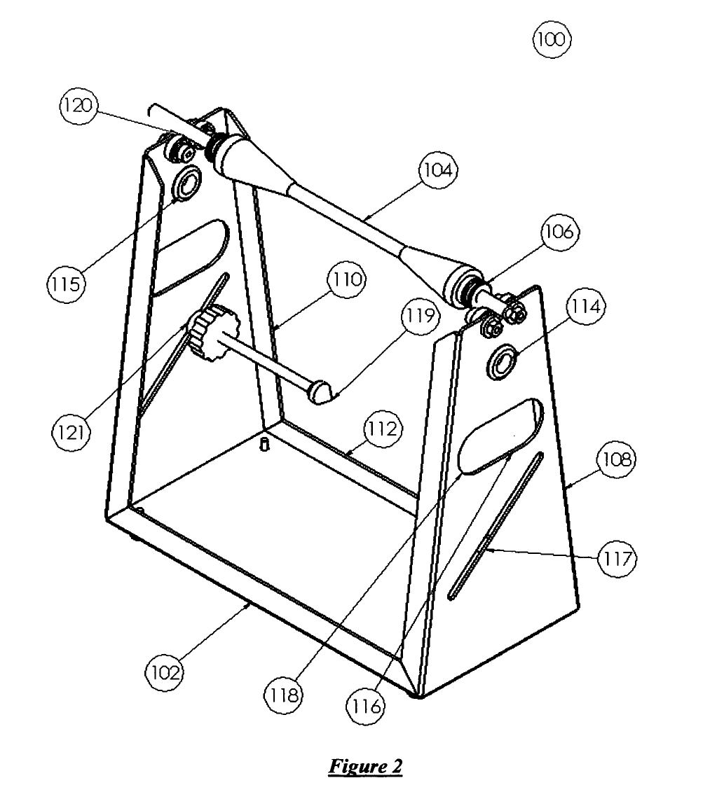

Referring to FIGS. 1 & 2, a tire balancing device 100 is depicted comprising of a frame 102, arbor 104, and at least one locking mechanism 106. in some embodiments, as depicted in FIG. 2, device 100 can comprise two locking mechanisms. Frame 102 can comprise two vertical members 108, 110 and horizontal member 112 can be composed of ⅛″ thick steel plates, which can provide for desired levels of durability, rigidity and stability. One of ordinary skill in the art will recognize that additional materials for forming vertical members 108,110 and horizontal member 112 are contemplated and are within the scope of the present disclosure.

In some embodiments, vertical members 108, 110 can include storage openings 114 adapted to receive and store arbor 104. The size and cross-sectional shape of storage openings 114 can be guided by the corresponding size and cross-sectional shape of arbor 104. In some embodiments, storage openings 114 can be lined with a polymeric material 115 such as, for example, natural or synthetic rubber to reduce wear or impact damage to arbor 104 when arbor 104 is positioned within the storage openings 114. Additionally, vertical members 108, 110 can include handle openings 116, which facilitate moving device 100. In some embodiments, handle openings 116 can also be lined with a polymeric coating 118. Vertical members 108, 110 can each include truing opening 117 and a truing indicator 119. Truing indicator 119 can be a rod that extends inward. Truing indicator 119 can be operably coupled to attachment portion 121, which can be locating within the truing opening 117 such that the height of truing indicator 119 can be adjusted to suit the diameter of the wheel assembly. One will notice that the angle of the truing opening facilitates a higher resolution adjustment relative to the diameter of the wheel versus a radially placed slot.

As depicted in FIG. 2, during use of tire balancing device 100, arbor 104 can be positioned on bearing cradle 120. In one embodiment, bearing cradle 120 can comprise a plurality of substantially circular bearings that engage arbor 104 during use of tire balancing device 100. The circular bearings facilitate supporting arbor 104 and also permit arbor 104 to rotate freely. As depicted in FIGS. 1 and 2, in one embodiment, vertical members 108, 110 can each have a bearing cradle comprising two substantially circular bearings. The size of bearings used to form the bearing cradle 120 can be guided by the diameter of arbor employed and the mass of the wheel & tire assembly for which the device will be utilized. In some embodiments, the bearing used to form the bearing cradle 120 can be formed from metal and can have a polymeric coating, or portion, located along at least the periphery surface of bearings to reduce wear to arbor 104 during use of device 100.

As described above, tire balancing device 100 can comprise arbor 104, which is adapted to engage a wheel assembly. In one embodiment, arbor 104 can comprise a rod or shaft having an elongated major axis relative to a minor axis. In some embodiments, arbor 104 can be completely symmetric and can have a circular cross-section, an oval cross-section or the like. In some embodiments, arbor 104 can be formed from stainless steel, which can increase the durability and useful lifetime of arbor 104. FIG. 5 depicts an arbor engaged with a wheel assembly, wherein the arbor is positioned within the bearing cradle of the frame.

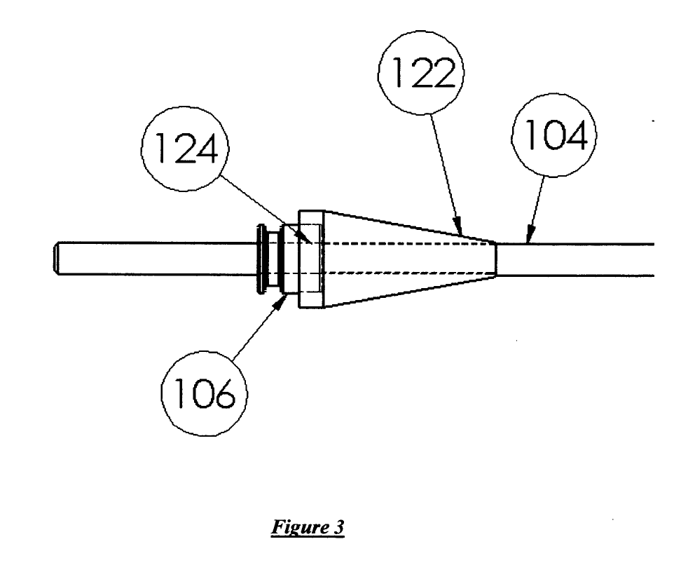

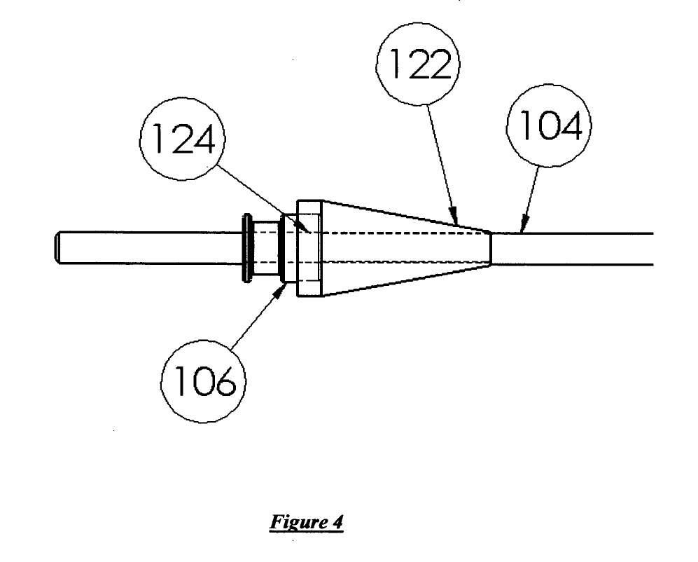

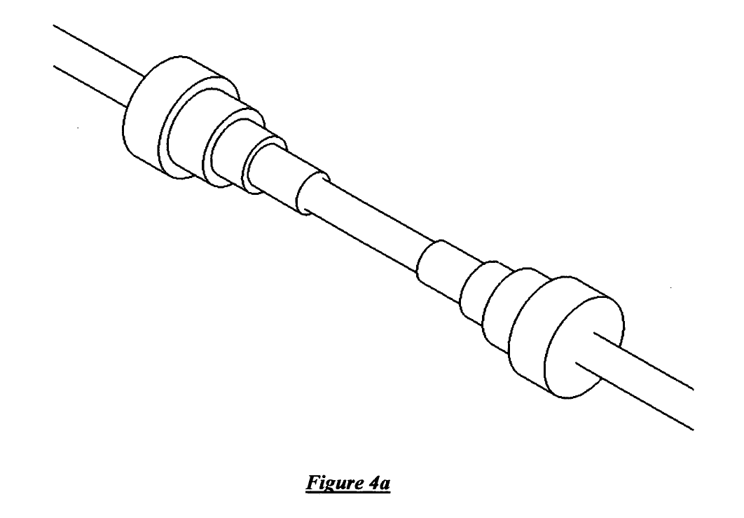

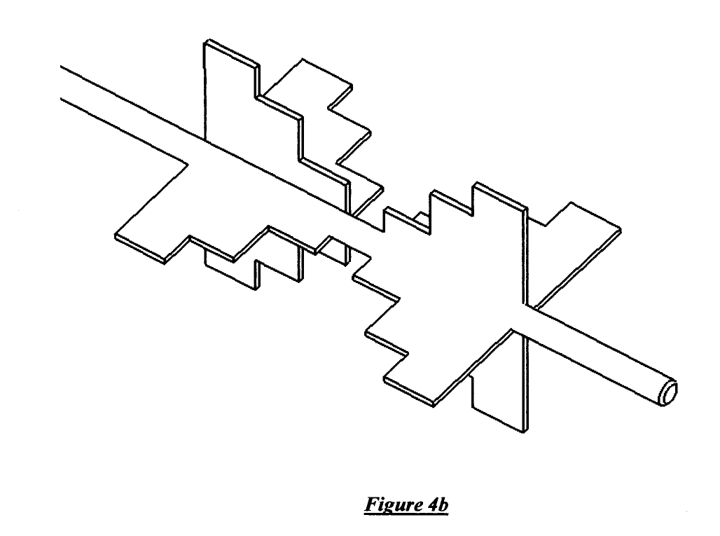

The tire balancing devices of the present disclosure can include at least one locking mechanism adapted to secure a wheel assembly to arbor 104. As described above, the locking mechanisms of the present disclosure can facilitate securing a wheel assembly to an arbor without the use of set screws, fasteners, or additional tools. Referring to FIGS. 3 & 4, locking mechanism 106 can include an engagement portion 122 and locking portion 124. As depicted in FIGS. 3 & 4, in some embodiments engagement portion 122 can be a cone shaped member adapted to engage the internal diameter of a wheel bearing. In some embodiments, the cones can be sized to operably couple with bearing having an internal diameter from about 10 mm to 100 mm or larger. As depicted in FIG. 4a, the cone shaped engagement portion can have step-like notches formed into the outer surface of the cone, which permits a single cone to operably couple with a plurality of wheel and/or bearing sizes. In other embodiments, as depicted in FIG. 4b, engagement portion 122 can comprise two plates that intersect each other at about a 90 degree angle. In some embodiments, the plate can have a substantially triangular shape.

Engagement portion 122 and locking portion 124 can include a bore adapted to receive arbor 104, which facilitates sliding locking mechanism 106 along the major axis of arbor 104. In some embodiments, locking portion 124 can comprise a locking release collar. Suitable locking release collars are described in, for example, U.S. Pat. No. 4,893,810 entitled “Quick Release Collar”, and U.S. Pat. No. 6,007,268, entitled “Radial and Axial Locking Release Collar”, which are both incorporated by reference herein. Additionally, suitable locking release collars are sold under the trade name Grip Fast™ by Specialized Marketing International, Inc. (Wauregan, CT).

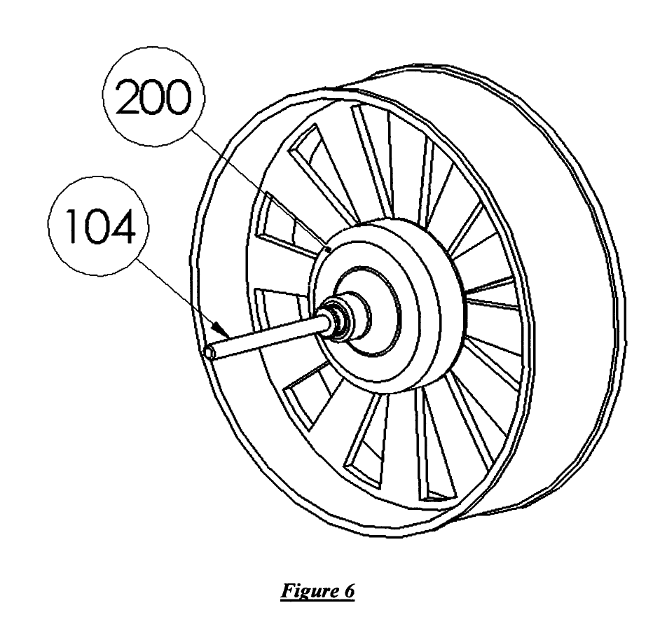

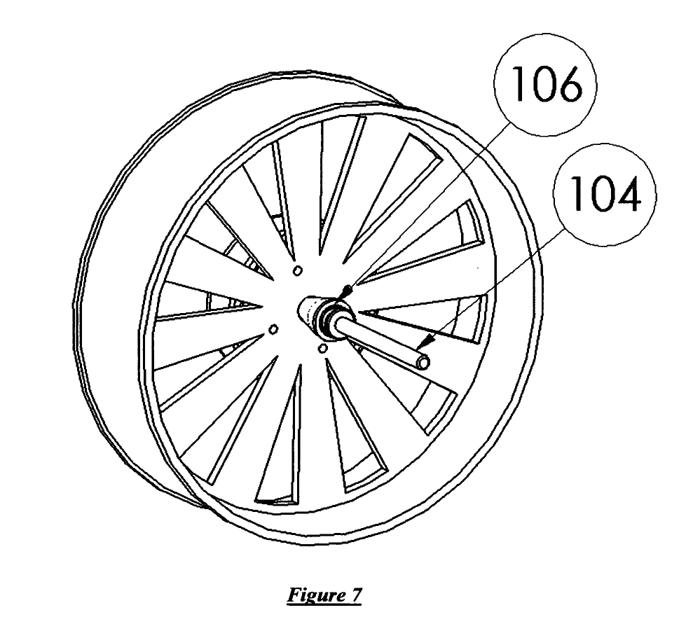

Referring to FIGS. 6 & 7, some rims and/or wheel assemblies cannot be secured to an arbor using two of the above described locking mechanisms, since the center of the rim is thin. In these embodiments, a cup 200 can be coupled to arbor 104 with a locking mechanism, ACME style threads, weldment, or other methods to hold rim 202 perpendicular to arbor 104, while locking mechanism 106 can be employed on the opposite side of rim 202 to hold the rim 202 concentric to arbor 104. Cup 200 can be sized such that a single cup can accommodate a variety of rims having a thin center portion. In some embodiments, the cup can have a cylindrical shape with a substantially circular cross-section. The diameter of the circular cross-section can be from about 2 inches to about 12 inches.

During use of a tire balancing device utilizing two locking mechanisms, one of the locking mechanisms is removed from the arbor prior to insertion into the wheel assembly. The arbor is then inserted into a wheel assembly until a second device engages the internal diameter of the wheel bearing. The wheel assembly can then be secured to the arbor by sliding the first locking device along the arbor until the first locing device engages the internal diameter of the wheel bearing on the opposite side of the wheel assembly relative to the second locking mechanism. The arbor can then be positioned on the bearing cradles of the frame and the tire can be balanced using traditional static balancing methods. The devices and methods of the present disclosure can be used to balance the tires of, for example, motorcycles, small aircraft, bicycles, sport-bikes, and some automobiles.

The embodiments above are meant to be illustrative and not limiting. Additional embodiments are within the claims. Although the present invention has been described with reference to particular embodiments, workers skilled in the art will recognize that changes may be made in form and detail without departing from the spirit and scope of the invention.

1. A locking device as disclosed herein.

2. The tire balancing devices as disclosed herein.

3. A method of balancing a tire as disclosed herein.
